(19) United States
(12) Patent Application Publication
(10) Pub. No.: US 2004/0003393 A1
(43) Pub. Date: Jan. 1, 2004

(54) Method, system and apparatus for monitoring use of electronic devices by user detection

(75) Inventors: Srinivas Gutta, Yorktown Heights, NY (US); Miroslav Trajkovic, Ossining, NY (US); Vasanth Philomin, Hopewell Junction, NY (US)

Correspondence Address: PHILIPS INTELLECTUAL PROPERTY & STANDARDS, P.O. BOX 3001, BRIARCLIFF MANOR, NY, 10510, US

(73) Assignee: Koninlkijke Philips Electronics N.V.

(21) Appl. No.: 10/180,599

(22) Filed: Jun. 26, 2002

(51) Int. Cl. H04N 7/16; H04N 7/167

(52) U.S. Cl. 725/25; 380/241

(57) ABSTRACT

A system, method, and apparatus suitable for automatically detecting certain supervised users of a device and alerting an authorized user of information regarding that use. When a particular, supervised user and device are recognized, the supervised user's use of the device is monitored by generating a usage history accessible to the authorized user.

### BACKGROUND OF THE INVENTION

1. Field of the Invention

The present invention relates to the field of consumer electronics, in particular to a system, method and apparatus for alerting and informing a parent or an otherwise authorized party about use of a television or other entertainment system.

2. Description of the Related Art

A “V-chip” function is commonly provided in television sets sold in the United States. The V-chip function in the television circuitry allows a parent or other party with access to the television control system to make certain programs received by the television unavailable to children or to other unauthorized viewers. Drawbacks of this system include the fact that it is not selective and may prevent access by other viewers who are not intended to be prevented from watching certain programs.

U.S. Pat. No. 5,715,014, to Perkins et al., teaches a circuit and method for providing parental discretionary control of a picture-in picture (PIP) channel integrated circuit for a video monitor.

U.S. Pat. No. 6,321,381 B1, to Yuen et al., teaches an apparatus and method for parental discretionary control in which a compressed code is entered for programs to be blocked or one or more programs is selected for blocking by parental control circuitry connected to a controller.

European Patent no, EP0806111 B1 to Yuen et al. discloses a PIP format for display of program related information such as television program listings from a program schedule data base in the background and moving real time or stored video clip images of a program selected from the displayed listings in the PIP window.

Application Ser. No. 09/460,943 of Sitnik, filed Dec. 14, 1999, Attorney Docket PHA 23,907 and application Ser. No. 09/460,944 of Sitnik, filed Dec. 14, 1999, Attorney Docket PHA 23,898A, which are incorporated by reference herein, disclose method and apparatus for connecting two or more televisions together to share identifying information about viewed audiovisual content.

Application Ser. No. 09/685,683 of Trajkovic et al., filed Oct. 10, 2000, Attorney Docket US000269, which is incorporated in its entirety by reference herein, discloses a system and method for automated control of devices based on images from a video capture device in the vicinity of the controlled device.

A monitoring system is known from Japanese Patent Publication Number 10248020A, to Hiyoshi (“Hiyoshi”). Hiyoshi teaches two televisions connected together in to enable a parent at one television to monitor the programs viewed by a child on the other television. The parent's television receives the image data from the child's television and displays the data on a corner part of the parent's television display. The received signal is always available on the parent's television.

There is, however, no teaching or suggestion in the prior art for establishing the identity a person in a viewing area, either in front of or within a certain distance of a television, other entertainment system or other consumer electronic device, and alerting a parent or other authorized person of the fact that the device is in use by the person identified and the use to which the device is being put. The prior art does not teach or suggest a television or other entertainment system which automatically detects a user who is a child or is otherwise subject to supervision and informs an authorized user, of the programs watched, their content, duration of use and other information regarding use of the particular item of consumer electronics. The prior art teaches or suggests only blocking programs or real time monitoring of programs that may be being viewed on a television in an area where a child or other user is often found. The present invention monitors and tracks programs actually watched and actual use of a consumer electronics device by a child or other user.

Furthermore, the present invention allows the programs actually watched by the child to be monitored and controlled directly by the parent, rather than a device which merely blocks out programs rated by others as possibly objectionable.

Accordingly it is an object of the present invention to provide a method and apparatus to allow a parent or an otherwise authorized user of a consumer electronic device to review, either in real time or by looking at a usage history, the use of a consumer electronics device by an individual who is subject to supervision. The present invention can alert a parent of unauthorized use and give the parent the ability to control the device while it is in use.

### SUMMARY

The present invention comprises a system, method, and apparatus suitable for automatically monitoring use by a child or other supervised individual, of a consumer electronics device and making information regarding that use available, either in real time or at a later time, to certain, authorized users of the device. The consumer electronics device may be a television, video cassette recorder, radio or other entertainment system, a telephone or any other device that can be connected to an in-home network.

In an exemplary embodiment, the present invention relates to real-time monitoring by a parent of the programs being watched by a child, in particular by means of the programs watched by the child being displayed as a picture-in-picture on a television being used by a parent. The present invention detects and identifies the child, maintains a usage history for him or her and transmits content identifying information to the authorized user or users. Content identifying information may include current channel tuning information, current channel audio information, samples of currently viewed content, control information to switch either a primary or secondary display (e.g., picture-in-picture) to the content viewed currently by the child and other types of information that may be conveyed about the content being viewed.

Differing methods of user detection and monitoring may be employed. By way of example and not limitation, face recognition software may be used. A child or other supervised user may also be presumed to be present if the use of the consumer electronics device takes place during certain hours, such as during the night, in an area such as a bedroom, where the child or other supervised user is expected to be present.

### BRIEF DESCRIPTION OF THE DRAWINGS

These and other features, aspects, and advantages of the present invention will become more fully apparent from the following description, appended claims, and accompanying drawings in which:

FIG. 1 is a generally perspective schematic view of an exemplary embodiment of the present invention;

FIG. 2 is a flow diagram of an exemplary method of the present invention;

FIG. 3 illustrates the prior art;

FIG. 4 is a flow diagram of an exemplary method of creating a usage history file; and

FIG. 5 shows an embodiment of the monitoring process.

### DETAILED DESCRIPTION OF A PREFERRED EMBODIMENT

In general, throughout this description, if an item is described as implemented in software, it can equally well be implemented as hardware.

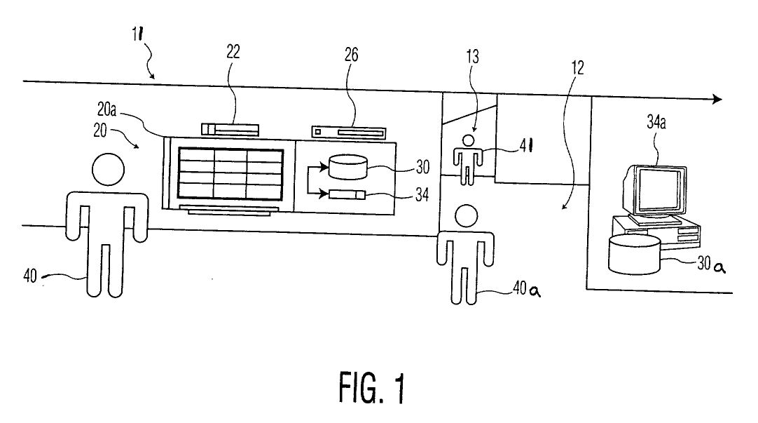

Referring to FIG. 1, the present invention is suitable for use with an entertainment system 20 such as a television 20a.

Detection system 22 senses when a child or other supervised user 40 is in a predetermined viewing area 11 proximate to television 20a. As used herein, “viewing area” may include not only the physical space proximate television 20a such as viewing area 11 but one or more adjacent viewing areas as well such as viewing areas 12 and 13 desired by a user 41 with authority to make set viewing area 11 boundaries.

Detection system 22 may be of any such system as will be familiar to those of ordinary skill in the detection arts, including by way of example and not limitation, input devices such as a television remote, biometric devices, set top boxes having recognition systems, including face and/or voice recognition systems, and the like, or a combination thereof. As used herein, “biometric devices” may include a face and/or voice recognition system, a fingerprint recognition system, a handprint recognition system, and the like, or combinations thereof. Gutta et al., Face and Hand Gesture Recognition Using Hybrid Classifiers, published in the PROCEEDINGS OF THE SECOND INTERNATIONAL CONFERENCE ON AUTOMATIC FACE AND GESTURE RECOGNITION of the Computer Society of the Institute of Electrical and Electronic Engineers, Inc. and Colmenarez et al., Maximum Likelihood Face Detection, published in the PROCEEDINGS OF THE SECOND INTERNATIONAL CONFERENCE ON AUTOMATIC FACE AND GESTURE RECOGNITION of the Computer Society of the Institute of Electrical and Electronic Engineers, Inc. are two examples of biometric recognition prior art.

Application Ser. No. 09/685,683 of Trajkovic et al., filed Oct. 10, 2000, Attorney Docket US000269, which is incorporated by reference, teaches an unobtrusive means for identifying a user and communicating the identity to a device controller.

Using detection system 22, a processor 34 automatically detects which user or users 40, 40a, 41 of the entertainment system 20 are within viewing area 11 of entertainment system 20. Using the information acquired by the detection system 22, the processor 34 identifies the detected user(s) 40.

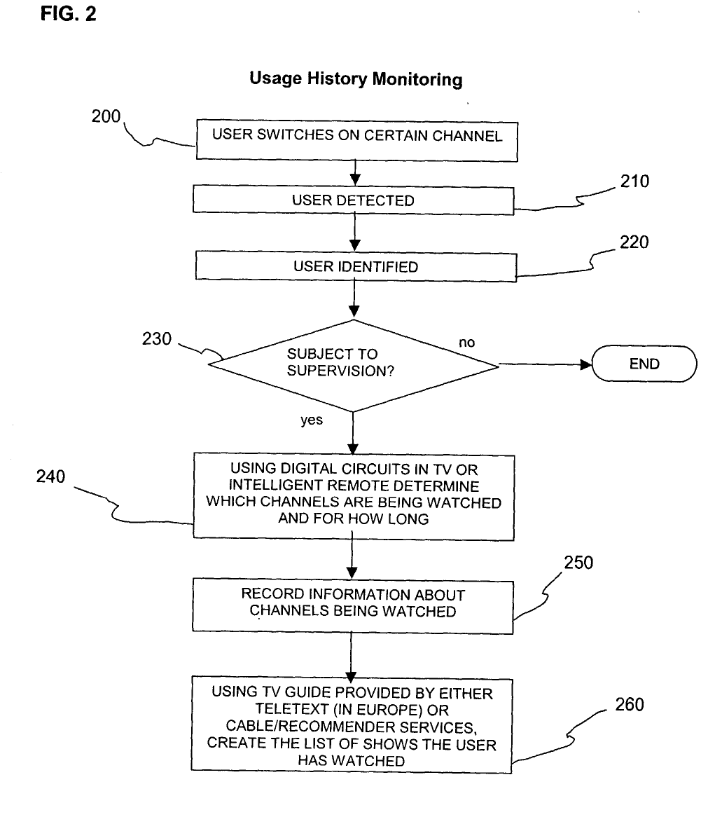

Referring to FIG. 2, when a user turns on 200 the television 20a or monitoring is otherwise triggered, such as by a timer, detection system 22 detects 210 users 40 who are within predetermined viewing area 11.

Processor 34 then determines 220 the identity of the detected user 40. In an exemplary embodiment, the identity of the detected user 40 is compared 230 against a set of supervised users' identities stored in persistent data store 30 to determine if a user is subject to supervision in his or her use of the television 20a. As noted above, persistent data store 30 may be a part of television 20a or may be accessible to the television 20a such as a hard drive 30a on personal computer 34a operatively connected to the television by connection means familiar to those of ordinary skill in the data communication arts.

Using electronic circuits already present in the television set, it is straightforward to determine 240 the content identifying information such as which channels are being watched and for how long, and record 250 the content identifying information in a specific file. A usage history for each supervised user can then be built 260 and displayed upon request by the authorized user 41. The authorized user 41 (the user who knows and enters the personal identification number (PIN) or is verified in any other way such as recognition systems including face and/or voice recognition systems and/or other biometric devices) can view this information displayed on television screen 34a at any given time. Moreover, to provide better control, we envision using a television camera built-into the television 20a to monitor, using face recognition systems that are well known in the art, who is watching the television.

Using techniques that are well known in the art, the processor can be programmed, for example, to generate an alarm when certain programs are watched and/or to cause the content identifying information to be transmitted to a television set in use where a parent is present and produce a primary or secondary, e.g. picture-in-picture (PIP), display on the parent's television. The parent or authorized user 41 may also access what the child or supervised user 40 is watching or has watched as stored in the child or supervised user 41 history file. The shows being watched or already watched may be displayed on the parent's monitor as a primary or secondary (PIP) display.

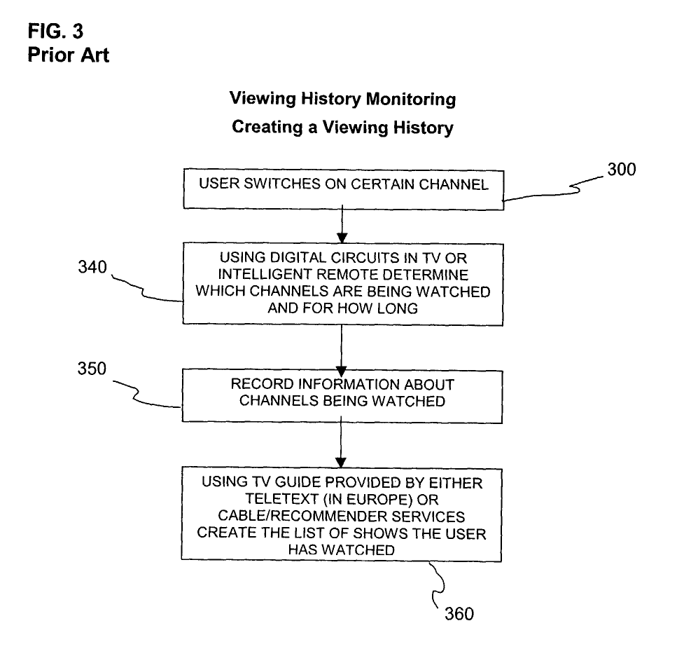

FIG. 3 illustrates the disadvantages of the prior art. Only the steps of turning on the television 300, determining 340 the content identifying information, recording 350 the content identifying information and building 360 the viewing history are present. Television programs are not necessarily watched. The television may be turned on without anyone watching it and the child's viewing habits criticized unjustly.

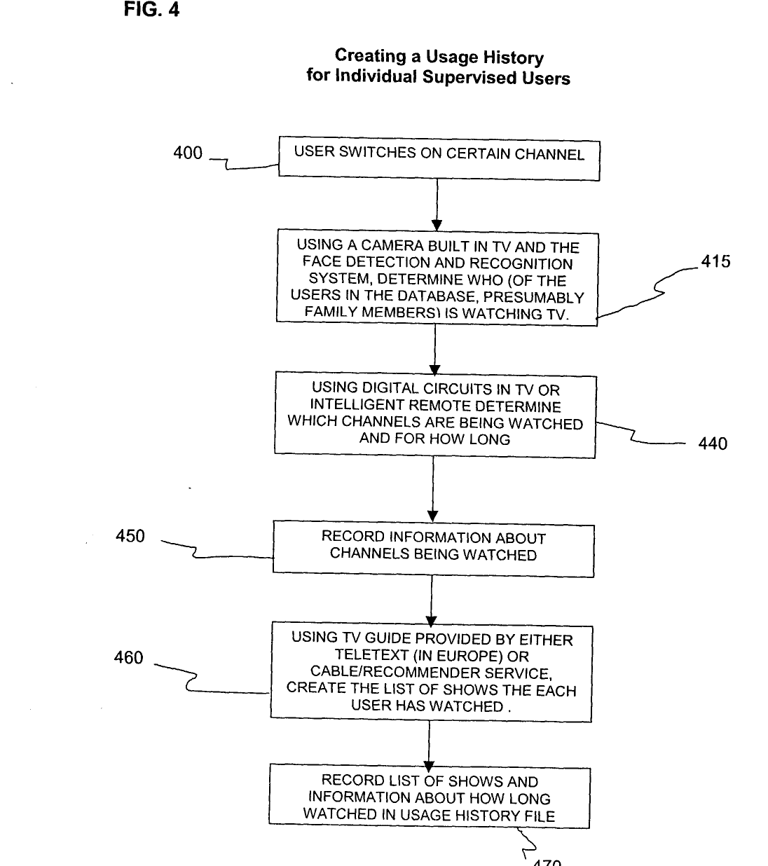

FIG. 4 exemplifies creating a usage history for an individual supervised user. A user 40 switches on 400 a certain channel on television 20a. The processor 34 using input from a detection system 22 which includes a camera built into the television 20a and face detection and recognition system or other biometric device or devices determines 415 who of the supervised users represented by files in the persistent data store 30 is watching the television. The processor then determines 440 which channels are being watched and for how long. This content identifying information is recorded 450. A usage history of shows watched is created 460 from the content identifying information using a TV guide such as those provided by teletex in Europe and by cable/recommender companies in the United States, and recorded 470 in a usage history file for the supervised user.

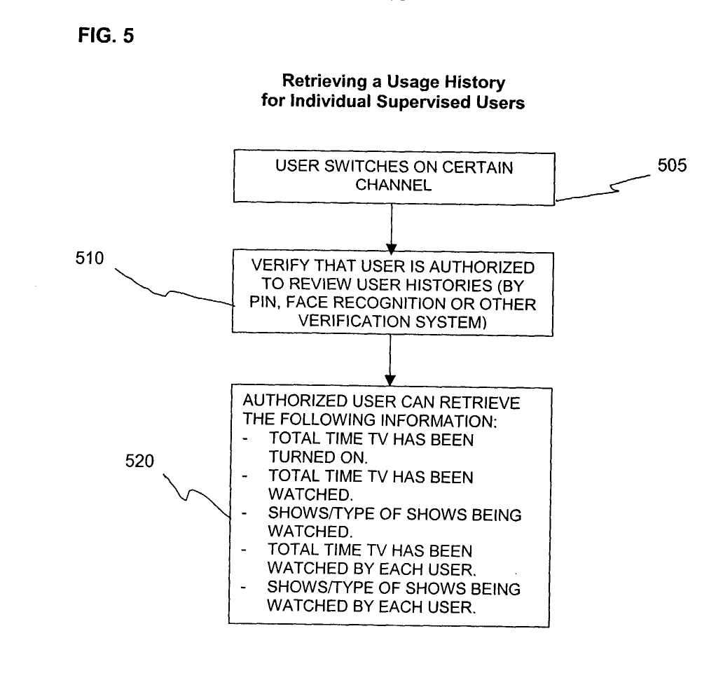

FIG. 5 shows an embodiment of the process of an authorized user's retrieving a usage history. An authorized user switches on 505 a certain channel and is required 510 to comply with a security restriction such as entering a password or PIN or automatically being recognized using a biometric devices or devices, before being allowed to program or reprogram the processor or access 520 usage history for supervised users, including information such as total time a TV has been turned on, total time TV has been watched, shows or type of shows being watched, total time TV has been watched by each user, and shows and type of shows being watched by each user.

It will be understood that various changes in the details, materials, and arrangements of the parts which have been described and illustrated above in order to explain the nature of this invention may be made by those skilled in the art without departing from the principle and scope of the invention as recited in the following claims.

What is claimed is:

1. An apparatus useful with consumer electronics devices, the apparatus comprising:
a persistent data store having a plurality of storage locations to store a plurality of user data for a corresponding plurality of consumer electronic devices and a plurality of supervised consumer electronics device users;
a user detection system; and
a processor, communicatively coupled to the persistent data store and the user detection system, the processor configured to:
a. automatically detect a supervised user of the plurality of supervised consumer electronics device users who is currently within a predetermined viewing area;
b. automatically detect which of the plurality of consumer electronics devices is in use by the detected supervised user;
c. automatically create at least one value of content identifying information relating to the use of the detected consumer electronics device by the detected supervised user; and
d. make the content identifying information available for display to an authorized user of the detected consumer electronics device.

2. The apparatus of claim 1 wherein the user detection system comprises an input device capable of transmitting at least one unique input and a computer vision system, a voice recognition system, a fingerprint recognition system or a handprint recognition system.

3. The apparatus of claim 2 wherein the computer vision system identifies faces in the detected imagery.

4. The apparatus of claim 1 wherein the content identifying information is displayed to the authorized user in real time.

5. The apparatus of claim 1 wherein the authorized user is identified in response to the input of a password.

6. The apparatus of claim 1 wherein the authorized user is identified using a biometric device.

7. The apparatus of claim 1 wherein the content identifying information is displayed using a TV guide.

8. The apparatus of claim 1 wherein the processor is further programmed to monitor interaction of one or more supervised users with an individual consumer electronics device, selectively store content identifying information about an interaction in a usage history and selectively retrieve from the usage history the content identifying information about the interaction.

9. The apparatus of claim 8 wherein the content identifying information about the interaction includes the length of time the consumer electronics device is in use.

10. The apparatus of claim 8 further comprising a parental control circuit connected to the consumer electronic device, the parental control circuit being configured to allow the authorized user to restrict use of all or of certain features of the consumer electronics device.

11. The apparatus of claim 1, wherein the consumer electronics device is a telephone.

12. The apparatus of claim 1 wherein the consumer electronics device is an entertainment system.

13. The apparatus of claim 10 wherein the entertainment system comprises a television set.

14. The apparatus of claim 13 wherein the content identifying information comprises information about television programs viewed by a supervised user.

15. The apparatus of claim 1 further comprising:
a connection configured to be operatively coupled to a connection to a display system; and
a processor configured to provide the content identifying information to the display system and configured to control conveyance of the content identifying information if the content identifying information is sent from the apparatus.

16. The apparatus of claim 15 wherein the display system is an alarm.

17. The apparatus of claim 15, wherein the display system is a television set.

18. The apparatus of claim 1 wherein the user detection system identifies a user as a supervised user by implication that only the supervised user can be present in the predetermined viewing area.

19. An entertainment system, comprising:
at least one entertainment system component providing programming available to at least one user, the programming being received by way of at least one input to the entertainment system component;
a persistent data store having a plurality of storage locations to store information about a corresponding plurality of entertainment system supervised system users, wherein at least one unique storage location is dedicated to store the information for a unique corresponding supervised system user and the information comprises supervised user preference data set by an authorized user for the supervised system user; and
a processor, operatively in communication with the at least one entertainment system component, the persistent data store, and a user detection system, the processor programmed to:
a. automatically detect which supervised users of the plurality of supervised entertainment system users are currently within a predefined viewing area;
b. automatically create a supervised user profile based on the information for each of the plurality of supervised users currently detected within the predefined viewing area; and
c. dynamically adjust operating parameters for the entertainment system in response to the supervised user profile.

20. The entertainment system of claim 19 wherein the adjustment of operating parameters for the entertainment system comprises blocking access to certain programs.

21. The entertainment system of claim 19 wherein the adjustment of operating parameters for the entertainment system comprises creating content identifying information for use of the entertainment system by the supervised system users.

22. The entertainment system of claim 21 wherein the processor makes the content identifying information available to the authorized user.

23. The entertainment system of claim 19 wherein the authorized user is identified in response to the input of a password.

24. The entertainment system of claim 19 wherein the authorized user is identified using a biometric device.

25. A method for monitoring use of a consumer electronics device, the method comprising:
automatically detecting one or more users within a predetermined viewing area;
determining whether or not each of the detected users is an individual whose use of the consumer electronics device is subject to supervision by an authorized user of the device;
for an identified, supervised user, determining content identifying information; and
making the content identifying information available to the authorized user.

26. The method of claim 25 wherein the authorized user is identified in response to the input of a password.

27. The method of claim 25 wherein the authorized user is identified using a biometric device.

28. The method of claim 25 wherein the consumer electronics device is an entertainment system.

29. The method of claim 25 wherein the entertainment system is a television.

30. The method of claim 25 wherein the content identifying information comprises current channel tuning information, current channel audio information, samples of currently viewed content and control information to switch to content viewed currently by the supervised user in a display in a monitor in use by the authorized user.

31. The method of claim 25 wherein the display in the monitor in use by the authorized user is a picture-in-picture display.

32. The method of claim 25 further comprising:
accumulating in a persistent data store, a usage history for each detected supervised user, the usage history comprising content identifying information; and
displaying all or part of the usage history to the authorized user upon demand by the authorized user.

33. The method of claim 25 further comprising preventing selection of an available entertainment option.

34. The method of claim 33 wherein the step of preventing selection of an available entertainment option further comprises preventing selection of available entertainment options only within a predetermined time frame.

35. The method of claim 34 wherein the predetermined time frame is a function of time of day or calendar time.

36. A computer program embodied within a computer-readable medium created using the method of claim 25.
